(19) United States
(12) Patent Application Publication
(10) Pub. No.: US 2011/0122655 A1
(43) Pub. Date: May 26, 2011

(54) POWER SUPPLY WITH AC/DC CONVERTER AND DC/AC INVERTER IN LOOP

(76) Inventor: Christopher T. Appel, New York, NY (US)

(21) Appl. No.: 12/624,057

(22) Filed: Nov. 23, 2009

(51) Int. Cl. H02M 3/22

(52) U.S. Cl. 363/15

(57) ABSTRACT

A power supply includes a DC/AC inverter and an AC/DC converter connected in a loop such that a DC output of the AC/DC converter is connected to a DC input of the DC/AC inverter and an AC output of the DC/AC inverter is connected to an AC input of the AC/DC converter. Another AC output of the DC/AC inverter is available to provide power to a load.

### TECHNICAL FIELD

The technical field of the apparatus disclosed herein relates to power supplies.

### BACKGROUND

Power supplies provide power to a wide variety of loads. A conventional power supply receives an AC input frequently from an outlet socket. This AC input is converted to DC by an AC/DC converter such as a rectifier and filter. The DC is then inverted to AC by a DC-AC inverter to provide AC output power.

This type of conventional power supply is not very efficient and requires AC power from an AC outlet. The apparatus described herein provides output power more efficiently and/or is portable.

### BRIEF DESCRIPTION OF DRAWINGS

FIG. 1 is a schematic showing an embodiment of a power supply;

FIG. 2 illustrates a front of a housing that contains the circuit of FIG. 1; and,

FIG. 3 illustrates a back of a housing that contains the circuit of FIG. 1.

### DETAILED DESCRIPTION

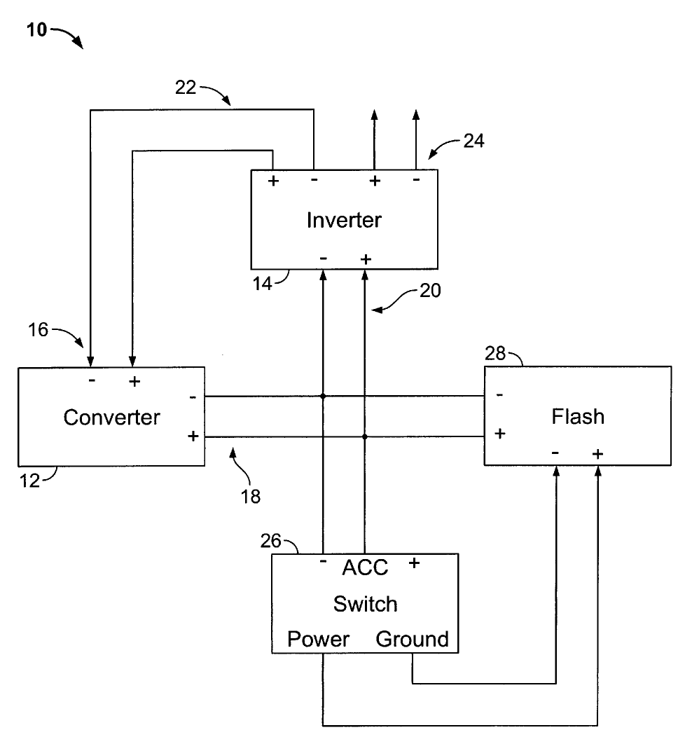

As shown in FIG. 1, a power supply 10 includes an AC/DC converter 12 and a DC/AC inverter 14. The AC/DC converter 12 includes an AC input 16 and a DC output 18, and the DC/AC inverter 14 includes a DC input 20 and dual AC outputs 22 and 24. The DC/AC inverter 14, for example, may be a Cobra CPI 475 inverter that inverts a 16 volt DC input at its DC input 20 into an output of 120 volts AC at each of the AC outputs 22 and 24. The AC/DC converter 12, for example, may be any suitable AC/DC adapter. For example, a Duracell model CEF 15 ADPUS that converts a 120 volt AC input at the AC input 16 to a 16 volt DC output at the DC output 18 supplied by certain surplus outlets may be used.

The AC/DC converter 12 and the DC/AC inverter 14 are coupled in a loop. That is, the AC output 22 of the DC/AC inverter 14 is coupled to the AC input 16 of the AC/DC converter 12, and the DC output 18 of the AC/DC converter 12 is coupled to the DC input 20 of the DC/AC inverter 14. The AC output 24 is available to power a load.

A switch 26 is coupled to both the DC/AC inverter 14 and to a flash unit 28. The switch 26 can be any suitable type of switch. In one example, the switch 26 may be a single pole, single throw switch, model number 275-601 supplied by Radio Shack, with power, ACC, and ground terminals.

The switch 26 has an off position and an on position. When the switch 26 is in the off position, the power supply 10 is off and no AC power is delivered to the AC outputs 22 and 24. When the switch 26 is in the on position, the power supply 10 is on, and the flash unit 28 is fired to deliver a momentary flash surge to the DC/AC inverter 14. The flash surge from the flash unit 28 causes AC current to flow from the AC output 22 of the DC/AC inverter 14 to the AC input of the AC/DC converter 12 which in turn causes DC current to flow from the DC output 18 of the AC/DC converter 12 to the DC input of the DC/AC inverter 14 in a long current sustaining loop. For example, in one test of the power supply 10, a battery was used in place of the flash unit 28 to produce 120 volt AC output power at the AC output 24 of the DC/AC inverter 14 sufficient to power a fan load connected to the AC output 24 for one hour without any significant drain on the battery.

The flash unit 28, for example, may be a Kodak Max Flash. The flash unit 28 includes batteries to charge a capacitor that creates the flash. Alternatively, the flash unit can be replaces by other current surging devices that do not require batteries. For example, the flash unit 28 can be replaced by a piezoelectric device that is arranged to produce a voltage spike for supply to the DC/AC inverter 14 upon activation of the switch 26.

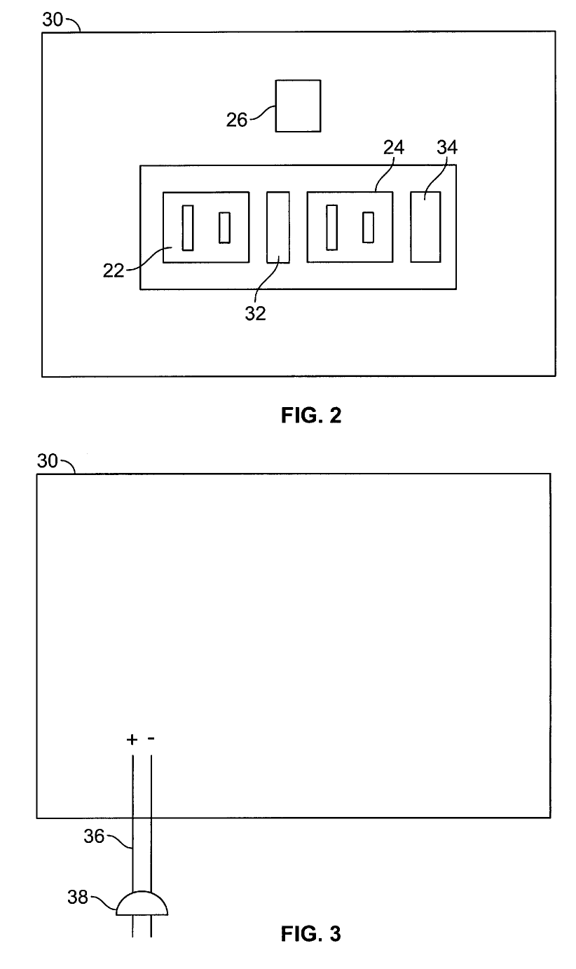

The power supply 10 is housed in a housing 30 the front of which is shown in FIG. 2. The front of the housing 30 supports the AC outputs 22 and 24 of the DC/AC inverter 14 and the switch 26. As indicated above, the AC output 22 of the DC/AC inverter 14 is coupled to the AC input 16 of the AC/DC converter 12, and the AC output 24 is available to power a load. The front of the housing 30 also supports a USB port 32 which is a standard part of a Cobra CPI 475 inverter. The front of the housing 30 further supports a switch 34 which also is a standard part of a Cobra CPI 475 inverter. The switch 34 may be used to turn the DC/AC inverter 14 on and off.

The back of the housing 30 is shown in FIG. 3. A cable 36 exits the back of the housing 30. The cable 36 at one end is electrically connected to the AC input 16 of the AC/DC converter 12 and at the other end has a plug 38 that is plugged into the AC output 22 of the DC/AC inverter 14. Alternatively, the cable 36 is not needed if the AC input 16 of the AC/DC converter 12 and the AC output 22 of the DC/AC inverter 14 are coupled to one another internally of the housing 30.

Modifications of the present invention will occur to those practicing in the art of the present invention. Accordingly, the description of the present invention is to be construed as illustrative only and is for the purpose of teaching those skilled in the art the best mode of carrying out the invention. The details may be varied substantially without departing from the spirit of the invention, and the exclusive use of all modifications which are within the scope of the appended claims is reserved.

What is claimed is:

1. A power supply comprising:
a DC/AC inverter having a DC input and first and second AC outputs;
an AC/DC converter having an AC input and a DC output, the first AC output of the DC/AC inverter being connected to the AC input of the AC/DC converter, the DC output of the AC/DC converter being connected to the DC input of the DC/AC inverter, and the second output of the DC/AC inverter being available to power a load; and,
an energy supply that supplies energy to at least one of the DC/AC inverter and the AC/DC converter.

2. The power supply of claim 1 wherein the energy supply is arranged to supply a momentary current surge to the at least one of the DC/AC inverter and the AC/DC converter.

3. The power supply of claim 1 wherein the energy supply comprises a flash unit.

4. The power supply of claim 1 wherein the energy supply comprises a piezoelectric device.

5. The power supply of claim 1 wherein the energy supply supplies energy to the DC/AC inverter.

6. The power supply of claim 5 wherein the energy supply comprises a flash unit.

7. The power supply of claim 5 wherein the energy supply comprises a piezoelectric device.

8. The power supply of claim 5 wherein the energy supply is arranged to supply a momentary current surge to the at least one of the DC/AC inverter and the AC/DC converter.

9. A power supply comprising:
a DC/AC inverter having a DC input and first and second AC outputs;
an AC/DC converter having an AC input and a DC output, the first AC output of the DC/AC inverter being connected to the AC input of the AC/DC converter, the DC output of the AC/DC converter being connected to the DC input of the DC/AC inverter, and the second output of the DC/AC inverter being available to power a load;
a switch; and,
an energy supply controlled by the switch to supply energy to at least one of the DC/AC inverter and the AC/DC converter.

10. The power supply of claim 9 wherein the energy supply is arranged to supply a momentary current surge to the at least one of the DC/AC inverter and the AC/DC converter upon activation of the switch.

11. The power supply of claim 9 wherein the energy supply comprises a flash unit.

12. The power supply of claim 9 wherein the energy supply comprises a piezoelectric device.

13. The power supply of claim 9 wherein the energy supply supplies energy to the DC/AC inverter.

14. The power supply of claim 13 wherein the energy supply comprises a flash unit.

15. The power supply of claim 13 wherein the energy supply comprises a piezoelectric device.

16. The power supply of claim 13 wherein the energy supply is arranged to supply a momentary current surge to the at least one of the DC/AC inverter and the AC/DC converter upon activation of the switch.

17. The power supply of claim 9 wherein the switch is arranged to turn the power supply on and off.
